(19) United States
(12) Patent Application Publication
(10) Pub. No.: US 2004/0036449 A1
(43) Pub. Date: Feb. 26, 2004

(54) Ultracapacitor-based power supply for an electronic device

(76) Inventors: Heather N. Bean, Fort Collins, CO (US); Mark N. Robins, Greeley, CO (US); Matt Flach, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/226,544

(22) Filed: Aug. 23, 2002

(51) Int. Cl. H02J 1/00

(52) U.S. Cl. 320/166

(57) ABSTRACT

An ultracapacitor-based power supply (Ultracapacitor Supply) and method power a portable electronic device. The Ultracapacitor Supply includes an ultracapacitor that stores energy rapidly relative to a battery-based power supply. The stored energy is used to provide primary power to the device. The electronic device includes operational electronics that require power to operate and an integral power supply. The device uses the Ultracapacitor Supply as one or both of the integral power supply and an auxiliary power source. As an auxiliary source, the Ultracapacitor Supply provides primary power to the device operational electronics from external to the device on a temporary basis when the device integral supply is depleted or otherwise unavailable. The auxiliary source serves as an emergency or back-up power supply. As the integral source, the Ultracapacitor Supply provides primary power to the operational electronics from inside the device on a relatively regular basis.

### TECHNICAL FIELD

The invention relates to portable electronic devices. In particular, the invention relates to a power supply for powering portable electronic devices.

### BACKGROUND OF THE INVENTION

Portable, battery-powered, devices, such as digital cameras for example, generally depend on a battery-based power supply for their operational power. In particular, a battery-based power supply that employs a rechargeable battery is often used in such portable battery-powered devices. The rechargeable battery of the battery-based power supply provides the device with operational power without requiring a continuous connection to a fixed power source, such as an alternating current (AC) electrical outlet, thus facilitating portable operation. The device can be operated from battery power until the battery becomes depleted. When depleted, the battery is either recharged in situ or is replaced with a fully charged, replacement battery.

Conventionally, to affect in situ battery recharging, an alternating current (AC) adapter and an associated power cord or power cords are employed. Typically, the AC adaptor is plugged into an available AC electrical power outlet and the associated power cable is plugged into a power input port of the device. The AC adaptor converts AC energy available from the electrical outlet into direct current (DC) energy that is then fed into the device to charge the batteries inside the device. During recharge, the device is fixed or tethered to the AC electrical power outlet. Thus, during recharge the device is rendered essentially non-portable. Fortunately, the power cable may be disconnected and the device once again regains its portability once the batteries are recharged.

Unfortunately, devices that utilize conventional battery-based power supplies and in situ recharging often suffer from a relatively slow recharge time of the battery. In particular, most conventional rechargeable batteries typically require about one hour to several hours to charge. Even modern, so-called ‘rapid charging’ batteries may take anywhere from several minutes to nearly an hour to acquire and store an energy charge level sufficient to power the device for a ‘normal’ operating period. Thus, the portable device is not truly portable during battery charging, since an electrical connection to a fixed energy source (e.g., the AC power outlet) tethers the device during in situ recharging.

In addition to dealing with a typically slow recharge period, a user of the electronic device must carry the power cord and AC adapter if the battery is likely to need recharging. Without the AC adaptor and power cord, the device is rendered useless once the battery becomes depleted. Moreover, even if the user remembers to take the power cord and AC adapter, the user may not have sufficient time to access a convenient AC electrical outlet to effect a recharging of the battery. Therefore, many users find it necessary to carry extra or spare batteries as a back up to a first set of batteries to insure that device operation is not interrupted due to depleted batteries. Furthermore, the user typically carries the spare batteries in addition to and not instead of the AC adaptor and power cord.

Accordingly, it would be advantageous to have a power supply for a portable electronic device, such as a digital camera, that could be re-charged much more rapidly than a conventional battery-based power supply. Furthermore, it would be desirable if such a power supply could eliminate the need to carry the ubiquitous AC adapter and power cable and a spare battery. Such a power supply would solve a long-standing need in the area of portable electronic devices.

### SUMMARY OF THE INVENTION

In representative embodiments, the present invention provides operational power for a portable electronic device from an ultracapacitor-based power supply. The ultracapacitor-based power supply employs an ultracapacitor, also known as a supercapacitor, instead of or in addition to a conventional battery to store and supply operational power to the electronic device. The ultracapacitor uses a capacitance to store power/energy, such that when stored energy becomes depleted, the ultracapacitor-based power supply recharges much more rapidly than a conventional battery-based power supply. According to the present invention, the ultracapacitor-based based power supply may serve as either a regular power source or as a back up, emergency, or auxiliary power source. The present invention is applicable to virtually any electronic device including, but not limited to, a digital camera, video camera, a laptop computer, a personal digital assistant (PDA), a pocket computer, a compact disk (CD) player, an MP3 player, a portable radio, an electronic toy, and a cellular telephone.

In an aspect of the invention, an ultracapacitor-based power supply for a portable electronic device is provided. The ultracapacitor-based power supply comprises an ultracapacitor that stores energy. The energy stored in the ultracapacitor provides a source of primary operational power to power the portable electronic device. In some embodiments, the ultracapacitor-based power supply is integrated into and provides primary operational power for the device on a regular basis. In other embodiments, the ultracapacitor-based power supply serves as a backup or auxiliary power supply for the electronic device. The ultracapacitor-based auxiliary power supply may provide short-term power to the electronic device when a primary power supply of the device is depleted or otherwise unavailable. In such embodiments, the primary power supply of the electronic device can be either a conventional battery-based power supply or an ultracapacitor-based power supply according to the present invention.

In another aspect of the present invention, a portable electronic device is provided. The portable electronic device comprises operational electronics and an integral power supply that supplies primary power to the operational electronics on a regular basis. The operational electronics and the integral power supply are enclosed in a device housing. In some embodiments, the integral power supply is an ultracapacitor-based power supply that comprises an ultracapacitor that stores energy used to power the operational electronics. In other embodiments, the portable electronic device comprises either the ultracapacitor-based power supply or a conventional power supply, such as a battery-based power supply. In these embodiments, the electronic device further comprises means for receiving auxiliary primary power from a portable external power source. The receiving means is enclosed by the device housing. The portable external power source provides primary power to the operational electronics when the integral power supply is unavailable. As such, the portability of the electronic device is maintained while receiving the auxiliary primary power. The portable external power source is an auxiliary ultracapacitor-based power supply comprising an ultracapacitor that stores energy used to provide the auxiliary primary power to the operational electronics. In yet another aspect of the present invention, a method of powering an electronic device comprising using an ultracapacitor-based power supply is provided.

Advantageously, the present invention powers an electronic device with a power supply that may be recharged in seconds or minutes instead of a matter of hours typical of conventional power supplies. Such a rapid recharge of a power supply for a portable electronic device greatly enhances the portability of the device, by reducing the time necessary to recharge a depleted power supply: Furthermore, when integrated into the electronic device, the present invention may eliminate the need for a conventional AC adaptor and power cord for the device. Such an integrated electronic device can directly ‘plug-in’ to an available AC electrical outlet. The ‘plug-in’ device, such as a plug-in digital camera, advantageously may be recharged simply by plugging the device into the AC electrical outlet for a matter of seconds or minutes. The recharged plug-in device is ready to use again as a portable electronic device. Moreover, as an auxiliary power supply, the present invention can enable a portable device with an otherwise depleted power supply to regain operation by providing a temporary, back-up power source, thereby enabling a user of the device to finish a task or activity involving the device. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a block diagram of an embodiment of an electronic device comprising an ultracapacitor-based power supply employed as a primary power supply according to the present invention.

FIG. 2 illustrates a block diagram of an embodiment of the ultracapacitor-based power supply of FIG. 1 according to the present invention.

FIG. 3 illustrates a perspective view of an embodiment of an electronic device in the form of an exemplary digital camera comprising an embodiment of an integral ultracapacitor-based power supply and a foldable AC plug according to the present invention.

FIG. 4 illustrates a block diagram of an embodiment of an ultracapacitor-based back up or auxiliary power supply for an electronic device according to the present invention.

FIG. 5 illustrates a perspective view of an embodiment of an electronic device that accepts auxiliary power comprising an embodiment of the ultracapacitor-based auxiliary power supply of FIG. 4 adapted for direct connection to an exemplary digital camera embodiment of the electronic device according to the invention.

FIG. 6 illustrates a perspective view of another embodiment of an electronic device that accepts auxiliary power comprising another embodiment of the ultracapacitor-based auxiliary power supply of FIG. 4 having a cable for interfacing to an exemplary digital camera embodiment of the electronic device according to the present invention.

FIG. 7 illustrates a flow chart of an embodiment of a method of powering an electronic device using an ultracapacitor-based power supply according to the present invention.

### MODES FOR CARRYING OUT THE INVENTION

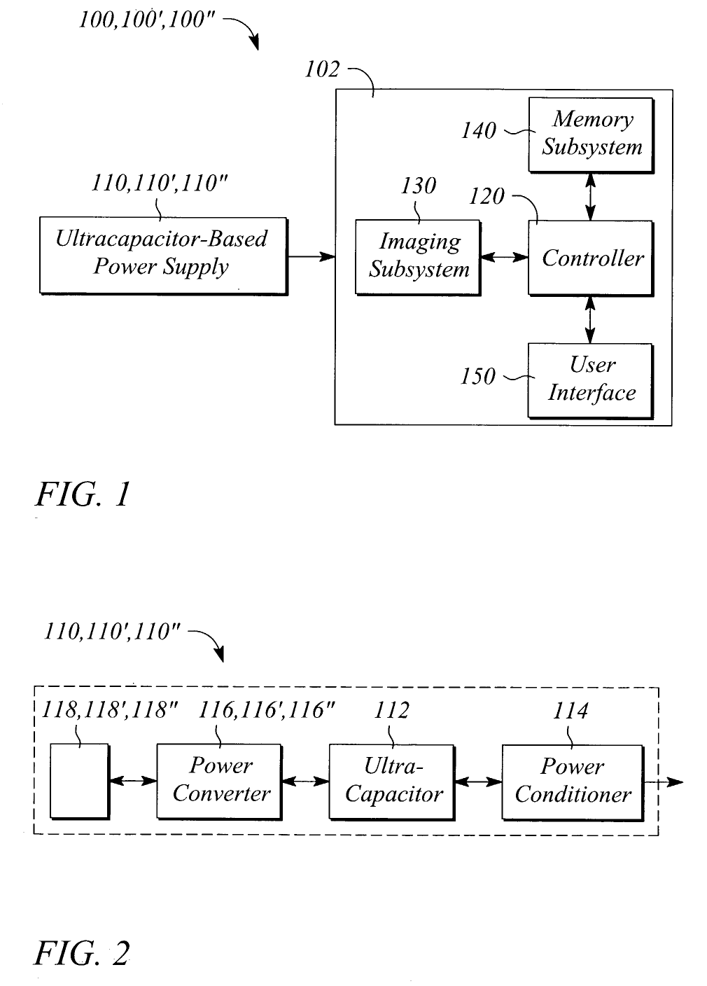

FIG. 1 illustrates a block diagram of an embodiment of an electronic device 100 comprising an ultracapacitor-based power supply 110 employed as a primary power supply according to the present invention. The electronic device 100 comprises an ultracapacitor-based power supply 110 and operational electronics 102. The ultracapacitor-based power supply 110 supplies power to electronics 102 thus powering the device 100. To facilitate further discussion, hereinbelow the electronic device 100 is illustrated and mostly described using an embodiment of a digital camera 100 by way of example. One of ordinary skill in the art can readily extend the discussion hereinbelow with respect to the exemplary digital camera 100 to other portable electronic devices 100, all of which are within the scope of the present invention.

As mentioned above, the ultracapacitor-based power supply 110 stores energy for and supplies operational energy to the exemplary digital camera 100. In particular, the ultracapacitor-based power supply 110 serves as a primary source of operational power/energy for the exemplary digital camera 100 to power electronics 102 of the digital camera 100. Energy stored in the ultracapacitor-based power supply 110 is consumed by the electronics 102 of the digital camera 100 to enable operation of the camera 100. An external source of energy, such as an AC electrical outlet or a DC auxiliary equipment port, is used to recharge or re-energize the ultracapacitor-based power supply 110, as required, when energy stored in the ultracapacitor-based power supply 110 is depleted. Through periodic recharging of the stored energy, the ultracapacitor-based power supply 110 enables the electronic device 100 to operate in a portable manner, essentially independent of the external energy source for extended periods of time.

FIG. 2 illustrates a block diagram of an embodiment of the ultracapacitor-based power supply 110 of FIG. 1 according to the present invention. The ultracapacitor-based power supply 110 comprises an ultracapacitor 112. The ultracapacitor 112, also sometimes referred to as a supercapacitor 112, is a capacitor having a capacitance that is typically orders of magnitude higher than that of a conventional capacitor. Unlike batteries which store and release energy by way of a chemical reaction, the ultracapacitor 112 stores energy as an electric charge on or associated with one or more electrodes. As such, the ultracapacitor 112 may be recharged or re-energized very quickly, typically on the order of seconds or minutes, instead of one to several hours typically required to recharge a rechargeable battery. The stored charge in the ultracapacitor 112 serves as a source of energy that powers the electronic device 100.

Most ultracapacitors are electrochemical capacitors that store energy electrostatically by polarizing an electrolytic solution. A voltage applied to an electrode suspended in the electrolyte polarizes the electrolyte and causes electrolyte ions to migrate to the electrode. The electrode acts as a first plate of a capacitor while the electrolyte ions act as a second plate. Since the plates so-formed are separated on the order of Angstroms from one another, capacitance per unit area of the electrode can be orders of magnitude higher than conventional capacitors with a pair of electrodes. In practice, an ultracapacitor is constructed with a pair of electrodes suspended in an electrolyte. When a voltage is applied to the electrode pair, electrolyte ions of a first polarity are attracted to a first electrode of the pair while electrolyte ions of a second polarity are attracted to a second electrode of the pair. Such electrochemical capacitors, having two, oppositely charged electrodes suspended in the electrolyte, are sometimes referred to as ‘double-layer’ capacitors owing to the formation of complementary polarized electrolyte ion layers at each electrode of the pair.

Electrochemical ultracapacitors generally employ a highly porous electrode material to further increase obtainable capacitances. For example, a porous carbon-based electrode material is used in ultracapacitors marketed under the trade name PowerCache® by Maxwell Technologies, San Diego, Calif., USA. Various polymer compounds are also employed as electrodes in ultracapacitors. For example, Rudge et al., U.S. Pat. No. 5,527,640, “Electrochemical Supercapacitors”, disclose an ultracapacitor that utilizes a polymer electrode. It is not the intent to limit the present invention to any particular ultracapacitor technology. The above-described ultracapacitors, as well as other ultracapacitors either known in the art or which may be developed, are within the scope of the present invention.

Referring again to FIG. 2, the ultracapacitor-based power supply 110 optionally further comprises means for power conditioning 114. An input of the power conditioning means 114 is connected to the output of the ultracapacitor 112. An output of the optional power conditioning means 114 is ultimately connected to the electronics 102 of the device 100. The power conditioning means 114 is any device or circuit that conditions a voltage and/or a current of the ultracapacitor 112, such that the voltage and/or current are made suitable for powering the electronics 102 of the electronic device 100.

In some embodiments, the power conditioner means 114 is a DC-DC converter that converts a voltage of the ultracapacitor 112 into another voltage that is better suited for powering the electronic device 100. The DC-DC converter 114 may be any of the various DC-DC converters known in the art including, but not limited to, linear regulators, switching regulators and converters, and charge pump converters. For example, the DC-DC converter 114 may be a MAX679 Step Up Regulated Charge Pump Converter marketed by Maxim Integrated Products, Sunnyvale, Calif., USA. The choice of a specific DC-DC converter 114 for a given electronic device 100 is dependent on the specific device 100 and electronics 102 thereof. One skilled in the art can readily make such a choice without undue experimentation.

Once again referring to FIG. 1, the electronics 102 of the exemplary digital camera 100 comprise a controller 120, an imaging subsystem 130, memory subsystem 140, and a user interface 150, all of which are powered by the ultracapacitor-based power supply 110. The controller 120 interfaces with and controls the operation of each of the imaging subsystem 130, the memory subsystem 140, and the user interface 150. Images captured by the optical subsystem 130 are transferred to the memory subsystem 140 by the controller 120 and may be displayed on a display unit of the user interface 150.

The controller 120 can be any sort of component or group of components capable of providing control and coordination of the imaging subsystem 130, memory subsystem 140, user interface 150, and in some embodiments, the ultracapacitor-based power supply 110. For example, the controller 120 can be a microprocessor or microcontroller. Alternatively, the controller 120 can be implemented as an application specific integrated circuit (ASIC) or even an assemblage of discrete components. One or more of a digital data bus, a digital line, or analog line may provide such interfacing. In some implementations of the exemplary digital camera 100, a portion of the memory subsystem 140 may be combined with the controller 120 and still be within the scope of the present invention.

In a representative embodiment, the controller 120 comprises a microprocessor and a microcontroller. Typically, the microcontroller provides much lower power consumption than the microprocessor and is used to implement low power-level tasks, such as monitoring button presses of the user interface 150 and implementing a real-time clock function of the digital camera 100. The microcontroller is primarily responsible for controller 120 functionality that occurs while the digital camera 100 is in a ‘stand-by’ or a ‘shut-down’ mode. The microcontroller executes a simple computer program. Preferably, the simple computer program is stored as firmware in read-only memory (ROM), the ROM preferably being built into the microcontroller.

On the other hand, the microprocessor implements the balance of the controller-related functionality. In particular, the microprocessor is responsible for all of the computationally intensive tasks of the controller 120, including but not limited to, image formatting, file management of the file system in the memory subsystem 140, and digital input/output (I/O) formatting for an I/O port or ports of the user interface 150. In a preferred embodiment, the microprocessor executes a computer program stored in the memory subsystem 140. Instructions of the computer program implement the control functionality of the controller 120 with respect to the digital camera 100.

The imaging subsystem 130 comprises optics and an image sensing and recording portion. The sensing and recording portion preferably comprises a charge coupled device (CCD) array. During operation of the camera 100, the optics project an optical image onto an image plane of the image sensing and recording portion of the imaging subsystem 130. The optics may provide either variable or fixed focusing, as well as optical zoom (i.e., variable optical magnification) functionality. The optical image, once focused, is captured and digitized by the image sensing and recording portion of the imaging subsystem 130. The controller 120 controls the image capturing, the focusing and the zooming functions of the imaging subsystem 130. When the controller 120 initiates the action of capturing an image, the imaging subsystem 130 digitizes and records the image. The recorded image is transferred to and stored in the memory subsystem 140 as an image file. The recorded image may also be displayed on a display of the user interface 150 for viewing by a user of the digital camera 100, as mentioned above.

The memory subsystem 140 comprises computer memory for storing digital images, as well as for storing the computer program. Preferably, the memory subsystem 140 comprises a combination of non-volatile memory (such as flash memory) and volatile memory (RAM). The non-volatile memory may be a combination of removable and non-removable memory and is preferably used to store the computer program and image files, while the RAM is used to store digital images from the imaging subsystem 130 during image processing. The memory subsystem 140 may also store a directory of the images and/or a directory of stored computer programs therein, including the computer program.

The user interface 150 comprises buttons and one or more displays. Preferably, the displays are each a liquid crystal display (LCD). One of the LCD displays provides the user with an indication of a status of the digital camera 100 while the other display is employed by the user to view images captured and recorded by the optical subsystem 130. The various buttons of the user interface 150 provide control input for controlling the operation of the digital camera 100. For example, a button may serve as an ‘ON/OFF’ switch for the camera 100.

Thus for the example embodiment of the digital camera 100, the DC-DC converter (i.e., power conditioning means) 114 converts a voltage of the ultracapacitor 112 into a voltage or voltages suitable for powering the controller 120, the imaging subsystem 130, the memory subsystem 140 and the user interface 150. An output of the DC-DC converter 114 is connected to a power supply input of each of the controller 120, imaging subsystem 130, the memory subsystem 140, and the user interface 150.

Referring again to FIG. 2, the ultracapacitor-based power supply 110 may optionally further comprise a power converting means 116, an output of which is connected to an input of the ultracapacitor 112, and a charging port 118 connected to an input of the power converting means 116. The power converter means 116 is any device or circuit used to convert power for the purpose of storing the power as energy in the ultracpacitor 112. The power converter means 116 receives power/energy through the charging port 118 from an external energy source while the ultracapacitor-based power supply 110 is electrically connected to the energy source. The power converter means 116 converts the energy received into an energy form suitable for energizing the ultracpacitor 112. The external energy source is any conventional external energy source, generally referred to herein as a ‘fixed’ external energy source, and is described further below. The converted energy produced by the power converter means 116 is stored by the ultracpacitor 112.

In some embodiments, the external energy source is an AC energy source such as a conventional AC electrical outlet. In such embodiments, the power converter means 116 is preferably an AC-DC converter 116 that converts an AC input voltage and current into a DC output voltage and a DC output current. For example, the AC-DC converter 116 may comprise a transformer and a rectifier. The transformer converts the input AC voltage having a first magnitude to a second AC voltage having a second magnitude. Typically, the first magnitude is greater than the second magnitude. The second AC voltage is then transformed or rectified by the rectifier into the DC output voltage. Preferably, the DC output voltage is suitable for energizing the ultracapacitor 112. The AC-DC converter 116 may further comprise a regulator portion or circuit. The regulator circuit regulates the DC output voltage and/or the DC output current. For example, the AC-DC converter 116 may convert an AC input voltage of 120 VAC into a regulated DC output voltage of 5 VDC. One skilled in the art is familiar with AC-DC converters 116 and could readily choose an appropriate converter 116 for a given application without undue experimentation. All of such converters are within the scope of the present invention.

In other embodiments of the electronic device 100′ and the ultracapacitor-based power supply 110′, the external energy source is a DC energy source including, but not limited to, an auxiliary equipment port in an automobile or an aircraft. For example, many automobiles are equipped with auxiliary equipment ports (e.g., cigarette lighters) that may function as a 12 VDC power/energy source. All such auxiliary equipment ports are considered herein as being conventional fixed external energy sources also for the purposes of the present invention. In such embodiments, the power converter means 116′ is a DC-DC converter 116′ and the charging port 118′ is adapted for the DC port. The DC-DC converter 116′ converts a DC input voltage and current of the DC energy source into a DC output voltage and current. Preferably, the converted DC output voltage/current is suitable for energizing the ultracapacitor 112. The DC-DC converter 116′ may further comprise a regulator that regulates the DC output voltage and/or a DC output current. For example, the DC-DC converter 116′ may convert a 12 VDC of an auxiliary equipment port in an automobile to a regulated 5 VDC output voltage. One skilled in the art is familiar with DC-DC converters 116′ and could readily choose an appropriate converter 116′ for a given application without undue experimentation. All of such converters are within the scope of the present invention.

It is also within the scope of the present invention for the ultracapacitor-based power supply 110″ to comprise a power converter 116″ that comprises both a AC-DC power converter 116 and a DC-DC power converter 116′ to provide added flexibility to the user of the electronic device 100″ that incorporates the dual power conversion 116″ in the ultracapacitor-based power supply 110″. In such embodiments of the ultracapacitor-based power supply 110″, the charging port 118″ comprises both a complementary interface 118 to an AC outlet and a complementary interface 118′ to a DC auxiliary port.

As mentioned hereinabove, an output of the power converter 116, 116′, 116″ is connected to the ultracapacitor 112 while the charging port 118, 118′, 118″ is connected to an input of the power converter 116, 116′, 116″. The charging port 118, 118′, 118″ serves as an interface between the power converter 116, 116′, 116″ and the external energy source. Usually, the charging port 118, 118′, 118″ is connected to the external energy source only when the ultracapacitor 112 is being charged. Thus, to charge the ultracapacitor 112, the charging port 118, 118′, 118″ is connected to the external energy source for the relatively very short period of time to energize the ultracapacitor 112.

In some embodiments of the electronic device 100, 100″ the charging port 118, 118″ comprises a retractable for foldable electrical plug 118. The retractable electrical plug may be constructed such that it may be plugged directly into a conventional AC electrical outlet when positioned in an extended or deployed configuration, for example. Thus, the retractable electrical plug 118 may be inserted into a two-prong or three-prong AC wall outlet when deployed. Once inserted into the AC wall outlet, AC current flowing from the AC wall outlet through the foldable electric plug 118 charges the ultracapacitor 112. When not plugged into the AC wall outlet, the retractable electric plug 118 may be stowed to protect the plug 118 and minimize interference by the plug 118 in the operation of the electronic device 100, 100″. The foldable electrical plug 118 is integral to the device 100, 100″ and to the ultracapacitor-based power supply 110, 110″ of the present invention, thus eliminating the need for a separate AC adaptor and power cord as typically required by a conventional electronic device.

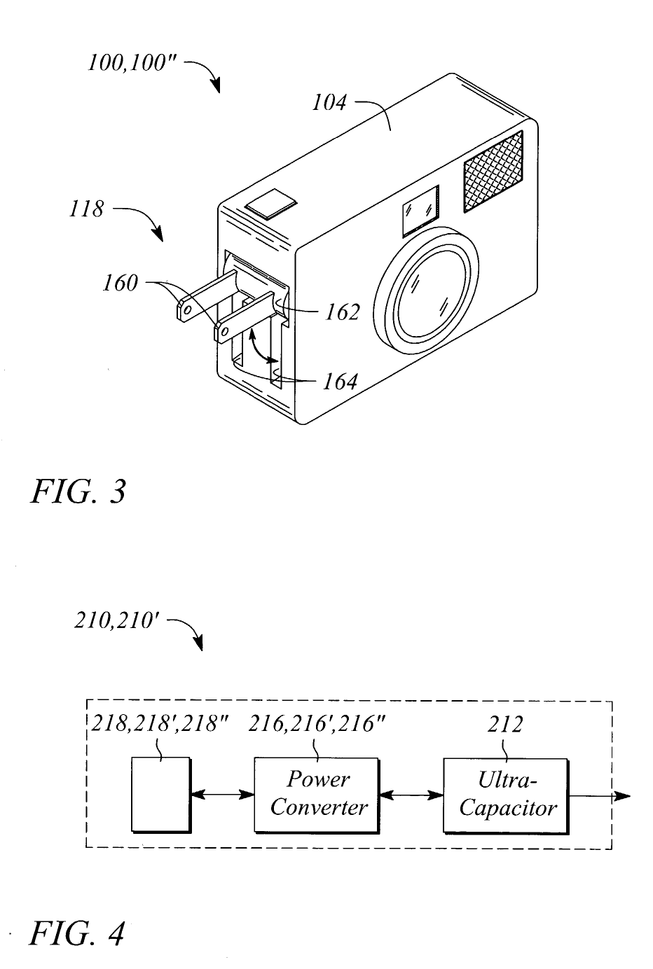

FIG. 3 illustrates a perspective view of an embodiment of an electronic device in the form of an exemplary digital camera 100, 100″ comprising an embodiment of an integral ultracapacitor-based power supply and a foldable AC plug 118 according to the present invention. As illustrated in FIG. 3, the foldable electric plug 118 is located at an end of a housing 104 of the exemplary camera 100. The foldable electric plug 118 comprises a pair of flat metal prongs 160 mounted to a rotatable cylinder 162. In a stowed position, the prongs 160 reside in a pair of slots 164 in the housing 104. To deploy the electric plug 118, the cylinder 162 is rotated as indicated by a double-headed arrow in FIG. 3. When deployed, the prongs 160 enable the exemplary camera 100, 100″ to be directly plugged into an available AC wall outlet to charge the ultracapacitor 112. In effect, the exemplary camera 100, 100″ with the foldable electric plug 118 is a ‘plug-in’ camera 100, 100″. When stowed, the prongs 160 are protected in the slots 164 and do not interfere with the operation or use of the exemplary camera 100, 100″. Other configurations including, but not limited to, retractable prongs 160 are possible for the foldable or retractable electric plug 118. All such other configurations are within the scope of the present invention.

As described above for the integral, foldable electric plug 118 that interfaces to an AC outlet, the charging port 118′, 118″ comprises an integral DC port-complementary complementary plug 118′ to interface to a DC port. The DC-complementary plug 118′ may be retractable or foldable and may have one or more of the advantages of being protected by the device housing 104 and not interfering with device use and operation, also as described above.

FIG. 4 illustrates a block diagram of an embodiment of an ultracapacitor-based back up or auxiliary power supply 210 for an electronic device 200 according to the present invention. As mentioned above, the portable electronic device 200 may be a digital camera, for example, or another of the above-mentioned electronic devices. However in this aspect of the invention, the electronic device 200 accepts auxiliary power from the ultracapacitor-based auxiliary power supply 210. As an auxiliary power supply, the ultracapacitor-based power supply 210 typically is not integrated into the electronic device 200. Furthermore, the ultracapacitor-based auxiliary power supply 210 typically provides short-term, ‘emergency’ or back-up power to the electronic device when a primary power supply of the device is depleted or otherwise unavailable. The primary power supply may be either a conventional battery-based power supply or the integrated ultracapacitor-based power supply 110, 110′, 110″ described hereinabove. According to some embodiments, the ultracapacitor-based auxiliary power supply 210 may provide power to charge the primary supply. Preferably however, the electronic device provides a bypass of the primary supply, such that when the auxiliary supply 210 is being used, the auxiliary supply 210 powers the device and does not charge the primary supply.

The ultracapacitor-based auxiliary power supply 210 comprises an ultracapacitor 212, a power converting means 216, and a charging port 218. The ultracapacitor 212 is connected to an output of the power converting means 216. An input of the power converting means 216 is connected to the charging port 218. Energy supplied by an external source is accepted by the charging port 218, transformed by the power converting means 216 and used to charge or re-energize the ultracapacitor 212. The stored energy in the ultracapacitor 212 is then available to power the electronic device for a short period of time as a back-up power source.

The ultracapacitor 212 is similar to that described hereinabove with respect to the ultracapacitor 112 of the electronic device 100, 100′, 100″. In some embodiments, the ultracapacitor 212 may be smaller (i.e., have a lower total capacitance) than that of the ultracapacitor 112 since the ultracapacitor 212 need only store enough energy to power the device for the relatively short period of time associated with using the auxiliary power supply 210. In other embodiments, the ultracapacitor 212 may be as large as or larger than the ultracapacitor 112, such that the auxiliary power supply 210 is capable of powering the device for extended periods of time. Likewise, the power converting means 216 is described hereinabove with respect to the power converting means 116, 116′, 116″ of the device 100, 100′, 100″ and ultracapacitor-based power supply 110, 110′, 110″.

The charging port 218 is preferably a foldable or retractable electrical plug 218 that may be plugged directly into a conventional AC electrical outlet and/or a conventional DC port, such as a standard two-prong or three-prong AC electrical wall outlet or a standard cigarette-lighter auxiarily port, respectively, for example. More preferably, the foldable or retractable electrical plug 218 is integrated into a housing of the ultracapacitor-based auxiliary power supply 210. Plugging the auxiliary power supply 210 into an outlet or port of the external energy source enables the ultracapacitor 212 to be charged. Once charged, the ultracapacitor-based auxiliary power supply 210 may be unplugged from the external energy source. The energy stored in the ultracapacitor 212 may then be used to supply power to the electronic device, as needed.

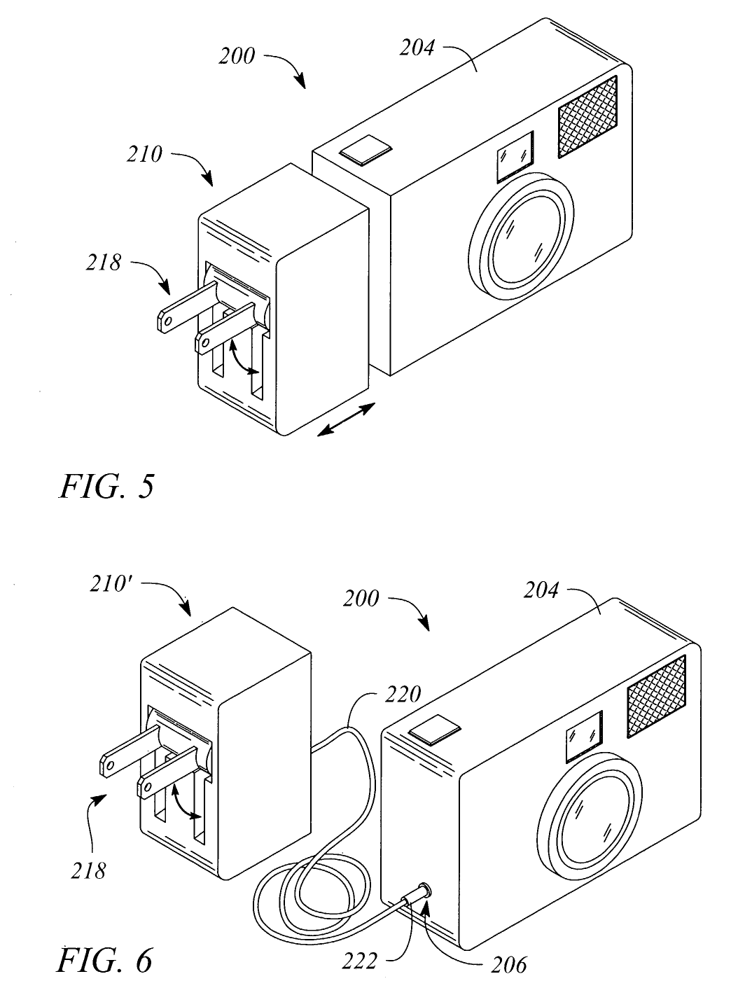

FIG. 5 illustrates a perspective view of an embodiment of an electronic device 200 that accepts auxiliary power comprising an embodiment of the ultracapacitor-based auxiliary power supply 210 of FIG. 4 adapted for direct connection to an exemplary digital camera embodiment of the electronic device 200 according to the invention. By way of example, the electronic device 200 illustrated as an embodiment of a digital camera and the auxiliary power supply 210 is designed to snap onto an end of the camera 200 when being used for emergency power. Not illustrated in FIG. 5 is a complementary means for connecting the ultracapacitor-based auxiliary power supply 210 to the end of the electronic device 200. The complementary connecting means can be any conventional mating connector pair that provide for both an electrical connection as well as a mechanical or physical connection. As illustrated in FIG. 5, the auxiliary power supply 210 has a foldable electrical plug 218 that is similar to that described with respect to the foldable electrical plug 118 of the exemplary digital camera 100, 100″ illustrated in FIG. 3.

FIG. 6 illustrates a perspective view of another embodiment of an electronic device 200′ that accepts auxiliary power comprising another embodiment of the ultracapacitor-based auxiliary power supply 210′ of FIG. 4 having a cable for interfacing to an exemplary digital camera embodiment of the electronic device 200′ according to the present invention. In the embodiment illustrated in FIG. 6, the auxiliary power supply is connected to the electronic device 200′ using a power cord 220. The power cord 220 enables the auxiliary power supply 210′ to be carried conveniently in a pocket or purse while powering the electronic device 200′.

The electronic device 200′ has a connector 206 in the device housing 204 for receiving a complementary mating connector 222 at one end of the power cord 220. The power cord 220 can be readily removable and separate from either the auxiliary power supply 210′ or the electronic device 200′, or the power cord 220 can be a retractable, optionally nonremovable, power cord 220 from either the auxiliary power supply 210′ or the electronic device 200′. While illustrated in FIGS. 5 and 6 with a foldable electrical plug 218, the auxiliary power supply 210, 210′ may also be realized with a fixed plug 218. Moreover, the auxiliary power supply 210, 210′ may also be realized with a DC-port adaptable plug 218′, or both an AC-adapted plug and a DC-adapted plug 218″. Other embodiments not illustrated herein, such as an ultracapacitor-based auxiliary power supply that is adapted to be inserted in an electronic device in place of the primary power supply, such as a battery-based primary supply, or inserted into a battery compartment in place of a battery of the battery-based power supply, or that is designed to mate with a docking station connector on one side of the device are also within the scope of the present invention.

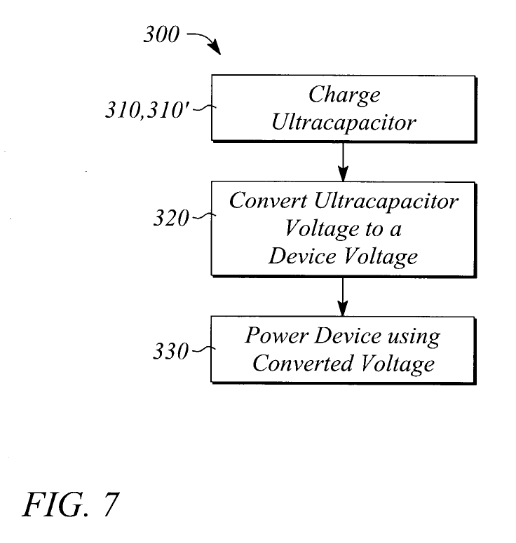

FIG. 7 illustrates a flow chart of an embodiment of a method 300 of powering an electronic device using an ultracapacitor-based power supply according to the present invention. The method 300 of powering the electronic device comprises energizing 310 an ultracapacitor using an external energy source. The external energy source is an AC electrical outlet or a DC auxiliary equipment port, for example. In some embodiments, energizing 310 comprises converting an AC voltage and AC current supplied by the AC electrical outlet into a DC voltage and current. In these embodiments, energizing 310 further comprises applying the DC voltage and DC current to the ultracapacitor. Applying the DC voltage and DC current to the ultracapacitor results in a charge being stored in the ultracapacitor. The AC voltage and AC current may be converted into a DC voltage and DC current by an AC-DC converter, for example.

In other embodiments, energizing 310′ comprises converting a DC voltage and DC current supplied by the DC port into a DC voltage and current suitable for the ultracapacitor. The DC voltage and DC current is applied to the ultracapacitor to store energy in the ultracapacitor. The DC voltage and DC current may be converted into the suitable DC voltage and DC current by a DC-DC converter, for example.

The method 300 further comprises converting 320 the energy stored in the ultracapacitor into a form suitable for powering the electronic device. In some embodiments, converting 320 comprises converting a voltage of the ultracapacitor into a voltage suitable for powering the device. In these embodiments, converting 320 may further comprise converting an ultracapacitor current to a current suitable for powering the device. When the energy stored in the ultracapacitor is discharged to convert 320 the stored energy, the discharged power produces the ultracapacitor voltage and ultracapacitor current. A DC-DC converter may be used to convert the ultracapacitor voltage and/or current, for example.

The method 300 further comprises powering 330 the electronic device using the converted energy from the ultracapacitor. The converted energy is in the form of the converted voltage and/or the converted current. In some embodiments, powering 330 the electronic device comprises applying the converted voltage and/or the converted current directly to circuitry of the electronic device to power the circuitry. In these embodiments, the ultracapacitor is essentially integral to the electronic device. In other embodiments, powering 330 comprises applying the converted voltage and current to an external power supply port of the electronic device. In these embodiments, the ultracapacitor is essentially external to the electronic device. When applied to the external power supply port, the converted voltage and/or the converted current may bypass a primary power supply of the electronic device to power 330 the circuitry of the electronic device directly. Alternatively, the converted voltage and current may pass through the primary power supply of the electronic device before powering 330 the circuitry of the device.

The method 300 of powering the device may serve as a primary power source for the electronic device, as is described above with respect to the electronic device 100, 100′, 100″ having an ultracapacitor-based power supply 110, 110′, 110″. Alternatively, the method 300 of powering the device may be employed for emergency or temporary powering of the device, as was described above with respect to the electronic device 200, 20′ that accepts an ultracapacitor-based auxiliary power supply 210, 210′. In either case, the method 300 of powering an electronic device employs energy stored as a charge in the ultracapacitor.

Thus, there have been described embodiments of an electronic device having an integrated ultracapacitor-based power supply, an electronic device that accepts auxiliary power from an ultracapacitor, an ultracapacitor-based auxiliary power supply for use with the electronic device, and a method of powering an electronic device using an ultracapacitor. It should be understood that the above-described embodiments are merely illustrative of the some of the many specific embodiments that represent the principles of the present invention. Those skilled in the art can readily devise numerous other arrangements without departing from the scope of the present invention as defined by the following claims.

What is claimed is:

1. An ultracapacitor-based power supply for a portable electronic device comprising:
an ultracapacitor, wherein energy stored in the ultracapacitor provides a source of primary operational power to power the portable electronic device.

2. The power supply of claim 1, wherein the ultracapacitor is integral to the portable electronic device to provide primary operational power on a regular basis.

3. The power supply of claim 1, wherein the ultracapacitor is separate from and connectable to the portable electronic device, the ultracapacitor providing auxiliary primary operational power to the electronic device on a temporary basis when connected to the electronic device, the auxiliary power temporarily replacing power from an integral primary power supply of the device when the integral primary power supply is one or both of depleted and unavailable.

4. The power supply of claim 3, wherein the portable electronic device comprises the integral primary power supply, the integral primary power supply being one of a battery-based power supply and the ultracapacitor-based power supply.

5. The power supply of claim 1, further comprising:
means for converting power acquired from an external energy source; and
means for connecting to the external energy source,
wherein an output of the power converting means is connected to the ultracapacitor, an output of the connecting means being connected to an input of the power converting means, and wherein the power acquired from the external energy source is stored as energy by the ultracapacitor.

6. The power supply of claim 5, wherein the power converter means comprises one or both of an alternating current (AC) to direct current (DC) converter to convert an AC external energy source and a DC-to-DC converter to convert a DC external energy source.

7. The power supply of claim 1, further comprising means for power conditioning connected to an output of the ultracapacitor, the power conditioning means modifying the energy stored in the ultracapacitor before the stored energy is provided to power the portable electronic device.

8. The power supply of claim 1, wherein the portable electronic device is one of a digital camera, a video camera, a laptop computer, a personal digital assistant, a pocket computer, a compact disk (CD) player, an MP3 player, a portable radio, an electronic toy, and a cellular telephone.

9. The power supply of claim 1, wherein the ultracpacitor is energized and re-energized rapidly relative to recharging a battery-based power supply.

10. A portable electronic device comprising:
operational electronics; and
an ultracapacitor-based power supply comprising an ultracapacitor,
wherein the ultracapacitor stores energy for and supplies primary operational power to the operational electronics, and
wherein the operational electronics and the power supply are enclosed together in a housing.

11. The device of claim 10, wherein the ultracpacitor-based power supply further comprises:
a charging port for connecting to an external energy source through a wall of the housing; and
means for converting power connected between the charging port and an input of the ultracapacitor,
wherein energy from the external energy source acquired with the charging port is converted by the power converting means into a form suitable for storage by the ultracapacitor.

12. The device of claim 11, wherein the charging port comprises a plug adapted to be received by one or both of an alternating current (AC) outlet connected to an AC energy source and a direct current (DC) auxiliary equipment port connected to a DC energy source.

13. The device of claim 12, wherein the charging port plug is integral to the housing, the plug being one of foldable against, retractable into and fixedly extended from the housing.

14. The device of claim 10, wherein the device is a digital camera, the operational electronics comprising:
a processor;
an imaging subsystem; and
memory,
wherein the processor controls the imaging subsystem and memory, the imaging subsystem being controlled to create digitized images as image files that are stored by the processor in the memory.

15. The device of claim 10, further comprising an integral electrical interface that extends externally from a wall of the housing, the interface being electrically connected through the housing wall to the enclosed ultracapacitor-based power supply, the interface being adapted to be received by an outlet of an external energy source, such that when the ultracapacitor periodically requires energizing, the interface is temporarily received by the outlet to energize the ultracapacitor.

16. An auxiliary ultracapacitor-based power supply for powering a portable electronic device comprising:
an ultracapacitor enclosed in a housing,
wherein the ultracapacitor serves as a short-term, auxiliary power source for the electronic device using energy stored in the ultracapacitor.

17. The auxiliary power supply of claim 16, wherein auxiliary power is provided to the electronic device as primary operational power when an integral power supply of the electronic device is one or both of depleted of power and unavailable to supply primary operational power.

18. The auxiliary power supply of claim 16, further comprising means for directly connecting the power supply housing externally to a wall of the electronic device, the connecting means temporarily attaching to the device wall to electrically connect the ultracapacitor to electronics within the device to provide auxiliary primary power.

19. The auxiliary power supply of claim 16, further comprising means for electrically connecting the ultracapacitor to electronics within the device to provide auxiliary primary power directly to the electronics, wherein the electrically connecting means comprises a power cord having a connector at one end that is adapted to be received by a mating connector of the device.

20. The auxiliary power supply of claim 16, further comprising:
a charging port for connecting to an external energy source through the housing; and
a power converter connected between the charging port and an input of the ultracapacitor,
wherein energy from the external energy source acquired through the charging port is converted by the power converter into a form suitable for storage by the ultracapacitor.

21. The auxiliary power supply of claim 20, wherein the charging port comprises an electrical plug that is one of foldable against, retractable into and fixedly extended from the housing, the plug being adapted to be received by one or both of an alternating current (AC) electrical outlet when the external energy source is an AC energy source and a direct current (DC) auxiliary equipment port when the external energy source is of a DC energy source.

22. An electronic device comprising:
operational electronics;
an integral power supply that supplies primary operational power to the electronics; and
means for receiving auxiliary primary power from a portable external power source when the integral power supply is unavailable, wherein the operational electronics, the integral power supply and the receiving means are enclosed by a device housing, and
wherein the receiving means receives auxiliary power from the portable external source, such that the portability of the electronic device is maintained while receiving the auxiliary primary power.

23. The portable electronic device of claim 22, wherein the portable external power source is an auxiliary ultracapacitor-based power supply comprising an ultracapacitor that stores energy that is used to provide the auxiliary primary power.

24. The portable electronic device of claim 23, wherein the ultracapacitor of the auxiliary ultracapacitor-based power supply is energized very rapidly relative to the integral power supply, such that auxiliary primary power is readily available when power from the integral power supply is depleted.

25. The portable electronic device of claim 22, wherein the auxiliary power receiving means comprises a device connector extending through a wall of the device housing, the portable auxiliary power source comprising a mating connector that is complementary to the device connector, such that when connected, the auxiliary power source is directly attached to the device housing wall and electrically connected to provide primary power to the operational electronics.

26. The portable electronic device of claim 22, wherein the auxiliary power receiving means comprises a device connector extending through a wall of the device housing, the portable auxiliary power source comprising a power cord and a mating connector at one end of the power cord, the mating connector being complementary to the device connector, such that when connected, the auxiliary power source is indirectly attached to the device housing wall and electrically connected to provide primary power to the operational electronics.

27. The portable electronic device of claim 23, wherein the auxiliary ultracapacitor-based power supply further comprises:
means for charging the ultracapacitor that is connectable to an external energy source; and
means for converting power from the external energy source to the ultracapacitor,
wherein the charging means is connected to an input of the power converting means, an output of the power converting means being connected to an input of the ultracapacitor, the charging port means comprising a port adapted to be received by one or both of an alternating current (AC) outlet of an AC external energy source and a direct current (DC) port of a DC external energy source, and
wherein the power converting means comprises one or both of an AC to DC converter and a DC-to-DC converter to convert energy from a respective external energy source into a DC energy that is suitable for storage in the ultracapacitor.

28. A method of powering an electronic device comprising:
energizing an ultracapacitor using energy acquired from an external energy source;
converting energy stored in the ultracapacitor into a form suitable for powering the device; and
powering the device using the converted energy.

29. The method of power of claim 28, wherein powering the device using the converted energy comprises one of applying the converted energy directly to circuitry of the electronic device and applying the converted energy to an external power supply port of the electronic device.

30. The method of claim 28, wherein the converted energy used for powering the device serves as a primary power source for the electronic device, and wherein powering the device using the converted energy is employed as one or both of an integral primary power source and as a temporary primary power source for the device, the temporary source being available when the integral primary power source is one or both of depleted and unavailable.
